(19) United States
(12) Patent Application Publication
(10) Pub. No.: US 2026/0098443 A1
(43) Pub. Date: Apr. 9, 2026

(54) CURTAIN BEAD WALKING DEVICE AND CURTAIN

(71) Applicant: SHAOXING ZHUOYA DECORATIVE MATERIAL CO, LTD., Shaoxing (CN)

(72) Inventor: Hecheng XU, Shaoxing (CN)

(21) Appl. No.: 19/416,120

(22) Filed: Dec. 11, 2025

Related U.S. Application Data
(63) Continuation of application No. PCT/CN2023/112811, filed on Aug. 14, 2023.

(30) Foreign Application Priority Data
Jun. 13, 2023 (CN) 202321501371.9

(51) Int. Cl. E06B 9/36; E06B 9/24

(52) U.S. Cl. CPC E06B 9/362; E06B 2009/2447

(57) ABSTRACT

The patent relates to a curtain bead walking device, including a partition and the lower part of the partition symmetrically set two hanging boards, the two hanging boards end upwardly curved and extended to form hooks, the two hooks are set relative to each other, the central part of the hanging boards is set with a vertical restriction strip, the restriction strip is set through the hooks, which will be divided into the left hook body and the right hook body, the said bead walking device also includes a hanging piece that is matched with the hooks, the central part of the said piece is set with the left hook body and the right hook body with the left hook slot and the right hook slot, the left hook slot and the right hook slot are set with through holes in their upper part.

### CROSS-REFERENCE TO RELATED APPLICATIONS

This application is a continuation of co-pending International Patent Application No. PCT/CN2023/112811, filed on August 14, 2023, which claims the priority and benefit of Chinese patent application number 202321501371.9, filed on June 13, 2023 with China National Intellectual Property Administration, the entire contents of which are incorporated herein by reference.

### TECHNICAL FIELD

The present patent relates to the field of curtains, and in particular relates to a curtain bead walking device and curtains.

### BACKGROUND

Vertical curtains are named because the leaves are hung vertically on the upper track, and can be freely dimmed left and right to achieve the purpose of shading. In the modern decoration by the young people's pursuit, because of its curtain piece of a single independent, and can walk through them, also called the dream vertical curtain. Vertical blinds using louvered structure, the page can be rotated, not only can adjust the indoor light, but also ventilation, but also to achieve the purpose of shading, by the modern young people's favorite. In practical application, due to the use of single hooks walking bead and the combination of the mother of pearl buckle hanging piece, the use of the mother of pearl buckle hanging piece of the adjacent curtain unit continuous combination of vertical curtain fabric, and then hung in the sliding connected to the track of the single hooks walking bead on the multiple, through the transmission mechanism to control the movement of the walking bead and rotation, so as to drive the whole vertical curtain opening and closing and adjusting the light. Cloth and yarn combined with one curtain is a curtain that consumers are looking forward to, the thinner the yarn mesh, the better, the more delicate, the better, the thicker the cloth, the better, the more sound insulation, the better, the better, the better, the better, the better, the better, the better, the better, the better, the better, the better, the better, the better, the better, the better, the better, the better.

Currently on the market when the curtain fabric stained, you need to open the mother and father buckle hanging piece, clean and re-buckle the mother and father buckle, and even when a single curtain fabric unit is broken, you need to open the mother and father buckle hanging piece, replace the new curtain fabric unit and then re-buckle. This frequent unlocking and fastening of the mother and father buckle hanging piece, a long time down not only easy to loosen and damage, but also does not facilitate the user to quickly replace. At the same time, the traditional curtain walking bead unit is also spaced apart from the curtain fabric by a distance, so that light and wind will be transmitted, which greatly reduces the light-blocking effect of the curtain.

For example, the patent patent of Chinese Patent No. 201721777911.0 discloses a curtain bead walking device including a main body and a gear, the gear including a first transmission gear, the first transmission gear rotationally fixed to the main body, and the distance from the axis of the first transmission gear to the edge of the main body is less than the radius of the toothed top circle of the first transmission gear. The gear also includes a worm and a worm wheel, and a blade catch is provided below the worm wheel, and the worm rotation drives the worm wheel to rotate, causing the blade catch to rotate. The bottom of the main body is provided with a guide groove, and the side of the main body is provided with a belt catch and a distance blade catch. This technical solution blade in will not be wind steering, a few blade stuck will not affect the other blade steering, can be applied to curved windows, running resistance is small, noise is small, long service life, due to the blade rotation required torque is small, can be used for larger, heavier curtains. However, it is unable to solve the above technical problems of quickly disassembling and replacing the curtain fabric as well as improving the shading effect of the curtains.

The technical problem to be solved by this patent is to overcome the existing technical defects and provide a curtain bead device and curtains, when the curtain fabric is damaged or dirty and needs to be replaced, it is only necessary to gently remove the hanging piece from the hook by hand, avoiding the inconvenience of frequently opening the mother and father buttons hanging piece in order to replace the curtains. The hanging piece is flexible and can be cleaned together with the curtain fabric, no need to disassemble the hanging piece and the curtain fabric for cleaning and replacement. The upper edge of the curtain fabric is 0-10mm higher than the upper edge of the hanging piece, so that the blank distance between the upper edge of the curtain fabric and the curtain track can be covered, so that the functions of the curtains of light blocking and heat insulation are greatly improved. The coordinated setting of the adjusting member and the through-hole is used to adjust the tilting angle of the hanging plate and the curtain cloth, so that the curtain cloth can be used more vertically .

### SUMMARY

The patent provides a curtain bead walking device and curtains for the drawbacks of the existing technology such as removing the curtain cloth is not easy to dismantle and the curtain shading effect is poor.

In order to solve the above technical problems, the patent can be solved by the following technical solutions:

A curtain bead walking device includes a partition and two hanging plates symmetrically set in the lower part of the partition, the ends of the two hanging plates are bent upward to form hooks, the two hooks are set opposite to each other, the middle part of the hanging plate is provided with a vertical limit strip, the limit strip runs through the hooks, and the hooks are divided into a left hook body and a right hook body, and the said bead walking device also includes a hanging piece which is compatible with the hooks, and the said middle part of the hanging piece is provided with a left hook body and a right hook body which are compatible with the left hook body and the right hook body, and the upper part of the left hook slot and the right hook slot is provided with through holes thereof. There are left hook slot and right hook slot in the middle of the hook piece, and the left hook slot and the right hook slot are provided with through holes in the upper part of the left hook slot and the right hook slot. The left and right hooks are used in conjunction with the two hanging tabs, so that the user can easily hang the tabs on the hooks or remove the tabs from the hooks, and the two tabs are independent of each other and have no connection, but are simply connected to the hooks, so that when the curtain fabric is damaged or dirty and needs to be replaced, the tabs can be gently removed from the hooks with the hand, thus avoiding the inconvenience of frequent opening of the mother-and-father clasp tabs for replacement of the curtains. The left hook body, the right hook body and the left hook groove, the right hook groove are compatible, so that the curtain fabric hangs firmly and is not easy to fall.

As a preference, said bead walking device includes two hanging plates and two hanging tabs cooperating with the two hanging plates, the hanging tabs are connected with the curtain fabric, and the connection between the curtain fabric and the hanging tabs is by sewing, heat fusion, bonding or welding. The connection method of the curtain fabric and the hanging piece can be customized according to the needs of the user, and different fixing methods have their respective advantages and disadvantages.

As a preferred option, the said hanging piece is thin, the upper edge of the hanging piece is lower than the upper edge of the curtain cloth 0-10mm. the hanging piece is relatively soft, flexible, can be cleaned together with the curtain cloth, no need to dismantle the hanging piece and the curtain cloth to clean and replace. Therefore, the combination of the hanging piece and curtain cloth products can be made into standard parts, mass production in advance, reduce the operating costs of enterprises, more social resources, reduce energy consumption, more environmentally friendly. Traditional curtain cloth after installation, often the upper edge of the curtain cloth and the curtain track has a distance between the distance in which there is no curtain cloth blocking, so it is the state of light and wind, which will greatly reduce the curtain cloth shading and heat insulation function, so the patent of the upper edge of the curtain cloth above the upper edge of the hanging piece of 0-10mm, so that it can be covered in this blank position, so that the curtain shading and heat insulation function is greatly improved. greatly improved.

As a preference, the width of said left hook slot and right hook slot is greater than the width of the left hook body and the right hook body. The setting of the width of the hook slot on the hook and the hanging piece can make it easier for the hook to snap into the inside of the hook slot, and the position can be easily deflected inside the hook slot.

As a preferred option, said bead walking device further includes a connecting member set on the upper part of the partition, and a bead walking groove which cooperates with the connecting member, and the bead walking groove drives the hanging plate and the hanging piece to move on the curtain track, thus driving the curtain fabric to move. The curtain track is in the shape of an elongated strip, and a transmission mechanism is provided at both ends of the track, and the track is hollow inside, and a belt groove is provided on the side wall of the track in the axial direction. A gear is fixedly provided at the top of the hanging plate, and the transmission mechanism drives the belt mechanism to move and drive the gear to rotate, which in turn drives the hanging sheet to rotate.

As a preference, an adjustment member for adjusting the tilt angle of the hanging plate and the curtain fabric is provided in said through hole. There is a certain error in the actual production and installation, vertical curtains to ensure that as vertical as possible, but the fabric has a certain degree of expansion and contraction, so the fabric is vertically falling with a certain degree of skewing, and can not ensure that the curtains are 100% vertical, so it is necessary to adjust the angle of draping of the curtain fabric, so that the curtain fabric is used as vertically as possible and consistent. Because the width of the left hook slot and the right hook slot is greater than the width of the left hook body and the right hook body, so the hook can be moved inside the hook slot position at will, when it is necessary to make the curtain cloth tilt to the left, rotate the adjusting piece or insert the left through-hole, at this time, the left hook body in the adjusting piece of the downward pressure of the left side is low and the right side is high, so that the hanging piece drive the curtain cloth to tilt to the left. Similarly, when it is necessary to tilt the curtain to the right, rotate the adjusting piece or insert it into the right hole, then the right hook body is low on the right and high on the left under the downward pressure of the adjusting piece, so the curtain is tilted to the right. The depth of the downward rotation or insertion of the adjusting member into the through-hole can be adjusted as desired.

A curtain comprising the above-described curtain walking bead device, a plurality of curtain walking bead devices are provided in a curtain track, which move left and right along the curtain track and rotate at a certain angle under the action of a driving device, thereby driving the curtain fabric to move left and right and rotate at a certain angle. One of the purposes of the patent is to realize that the curtain fabric is easy to dismantle, to meet the needs of replacement and washing, greatly saving costs, and avoiding the inconvenience of frequent dismantling of the sub-milk button. Consumers can easily replace the new fabric at home by themselves, the curtain fabric can be replaced at will according to different festive atmosphere, the curtain fabric is old, dirty, or don't like it, but also according to different festive atmospheres, can be replaced at will with their favorite color styles to decorate the interior environment, is very suitable for the young generation of consumers, but also very suitable for the old generation of frugal habits, and therefore can be mass-produced ahead of time to reduce the operation of the enterprise Therefore, it can be mass produced in advance, reduce the operating cost of the enterprise, save resources for the society, reduce energy consumption, and be more environmentally friendly.

As a preferred option, said curtain fabric consists of a light-blocking part and a light-transmitting part set alternately, said light-transmitting part is a light-transmitting muslin mesh, said light-blocking part is a light-impermeable cloth surface, when the adjacent light-blocking part is rotated to the horizontal position, the curtain as a whole is in a light-blocking state, when the adjacent light-blocking part is rotated to the vertical position, the curtain as a whole is in a light-transmitting state. When the light-blocking part and the light-transmitting part are rotated to a certain angle, the curtains present different degrees of light-blocking state, and the user can adjust any angle of the light-blocking part and the light-transmitting part to adjust the light-blocking state of the curtains according to the actual needs.

As a preferred option, two adjacent curtain walking bead devices are connected to the same piece of curtain fabric by adjacent hanging tabs on the two adjacent curtain walking bead devices. The first bead walking device hangs the left and right hanging tabs, the adjacent second bead walking device also hangs the left and right hanging tabs, and the right hanging tab on the first bead walking device and the adjacent left hanging tab on the second bead walking device, both of which are respectively connected to the left and right sides of the same piece of curtain fabric, and so on. The user can use different numbers of bead walking devices depending on the width of the window.

As a preference, the said partition, the connecting member at the upper part of the partition, and the hanging plate at the lower part of the partition are molded in one piece. The integrally molded fittings can be connected more firmly, and the user can use different connectors as well as bead walking grooves according to different curtain tracks.

The patent has the following significant technical effects due to the adoption of the above technical solutions:

When the curtain fabric is damaged or dirty and needs to be replaced, it is only necessary to gently remove the hanging piece from the hook by hand, which avoids the inconvenience of frequently opening the snap fastener hanging piece in order to replace the curtains. Hanging piece of good flexibility, can be cleaned with the curtain fabric, no need to disassemble the hanging piece and curtain fabric to clean and replace.

(2) The upper edge of the curtain fabric is 0-10mm higher than the upper edge of the hanging piece, which can cover the blank distance between the upper edge of the curtain fabric and the curtain track, so that the curtain's function of shading and heat insulation is greatly improved.

(3) The coordinated setting of the adjusting member and the through-hole is used to adjust the tilting angle of the hanging plate and the curtain fabric, so that the curtain fabric can be used more vertically.

### BRIEF DESCRIPTION OF THE DRAWINGS

FIG. 1 is a schematic diagram of the structure of the patent hanging plate.

FIG. 2 is a schematic diagram of the structure of the patent hanging plate.

FIG. 3 is a schematic diagram of the patent hanging plate used in conjunction with the hanging sheet.

FIG. 4 is a schematic diagram of the structure of the curtain fabric of the patent.

FIGS. 5-9 are schematic diagrams of the structure of the curtains of Examples 3-7 of the patent.

The names of the parts referred to by the numerical symbols in the accompanying drawings are as follows:

1-partition; 2-hanging plate; 21-hook; 22-limit strip; 23-left hook body; 24-right hook body; 3-hanging piece; 31-left hook slot; 32-right hook slot; 33-through hole; 34-adjustment member; 4-curtain fabric; 41-light-shading portion; 42-light-transmitting portion; 5-connection member; and 6-bead walking slot.

### DESCRIPTION OF EMBODIMENTS

The patent is described in further detail below in combination with the accompanying drawings and embodiments.

### Embodiment 1:

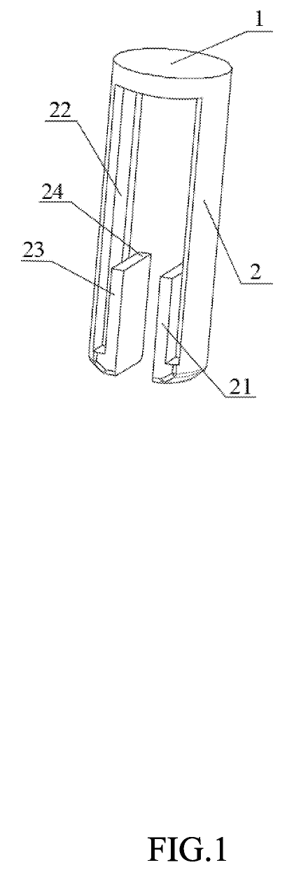

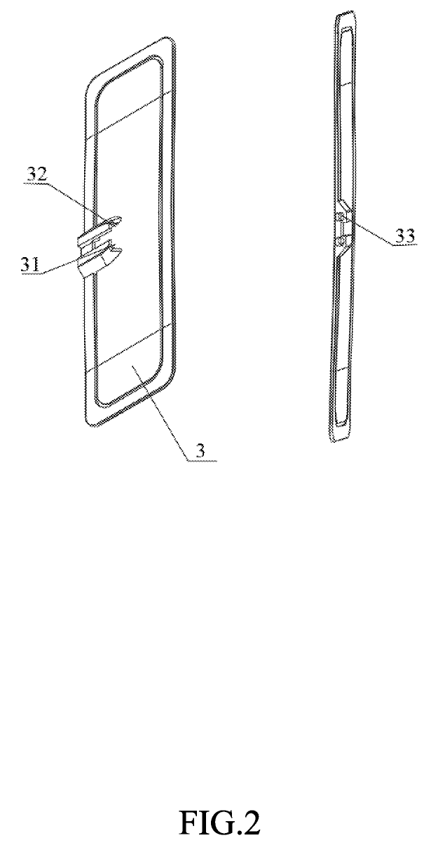

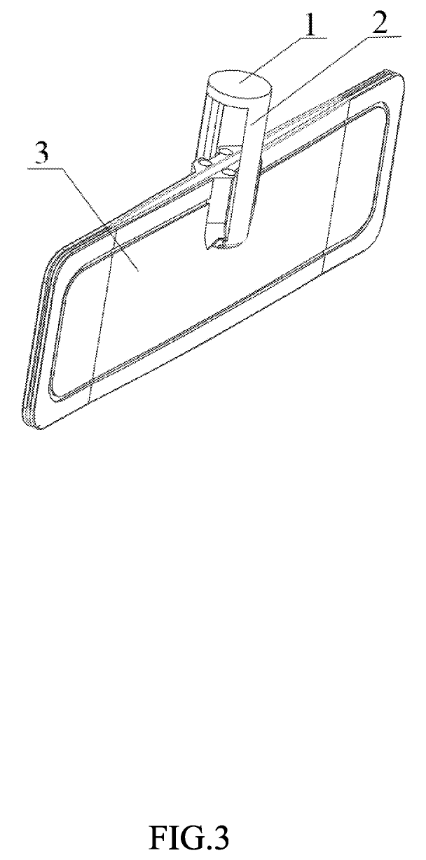

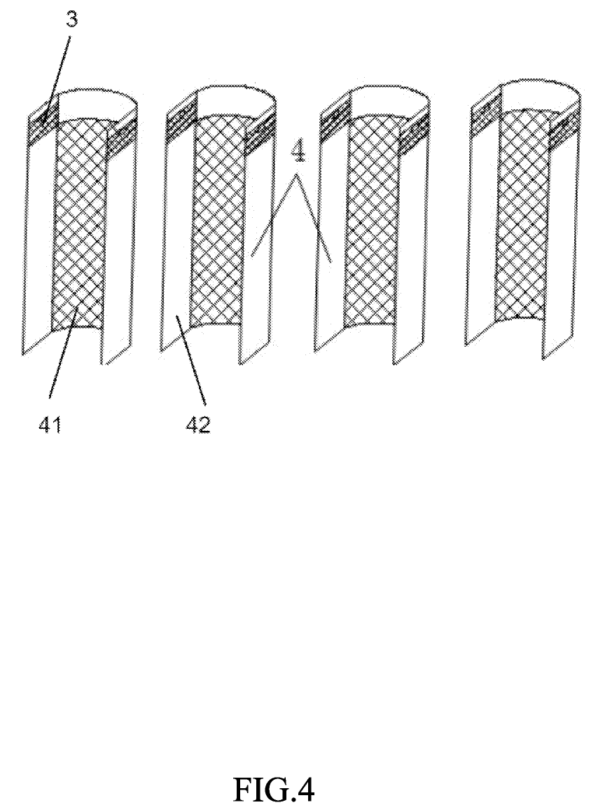

As shown in FIGS. 1-4, a curtain bead walking device includes a partition plate 1 and two hanging plates 2 symmetrically provided in the lower part of the partition plate 1, the ends of the two hanging plates 2 are bent upward to form hooks 21, and the two hooks 21 are set opposite to each other, and the middle part of the hanging plate is provided with a vertical limiting strip 22, which runs through the hooks 21, and splits the hooks 21 into a left hook 23 and a right hook 24, and the bead walking device also includes a hanging piece 3 which is compatible with the hooks, and a hanging piece 3 which is suitable for use with the hooks, and a hanging piece 3 which is suitable for use with the hooks. Said bead walking device also includes a hanging piece 3 which cooperates with the hook, said hanging piece is provided with a left hook slot 31 and a right hook slot 32 in the middle of said hanging piece which cooperates with the left hook body 23 and the right hook body 24 respectively, and the upper part of the left hook slot 31 and the right hook slot 32 is provided with a through-hole 33 which is connected to it.

Said bead walking device comprises two hanging plates 2 and two hanging tabs 3 cooperating with the two hanging plates 2, the hanging tabs 3 are connected with a curtain fabric 4, and the connection between the curtain fabric 4 and the hanging tabs 3 is by means of sewing, heat fusion, bonding or welding.

Said hanging piece 3 is in the form of a thin sheet, and the upper edge of the hanging piece 3 is 0-10 mm below the upper edge of the curtain fabric.

The width of said left hook slot 31 and right hook slot 32 is greater than the width of the left hook body 23 and the right hook body 24.

Said bead walking device further comprises a connecting member 5 provided in the upper part of the partition 1, and a bead walking groove 6 cooperating with the connecting member 5. The bead walking groove 6 drives the hanging plate 2 and the hanging piece 3 to move on the curtain track, thereby driving the curtain fabric 4 to move.

Said through-hole 33 is provided with an adjustment member 34 for adjusting the tilt angle of the hanging plate 2 and the curtain fabric 4.

### Embodiment 2:

A curtain comprising the above-described curtain walking bead device, a plurality of curtain walking bead devices are provided in a curtain track, which are moved left and right as well as rotated at a certain angle along the curtain track under the action of a driving device, thereby driving the curtain cloth 4 to move left and right as well as to rotate at a certain angle.

Said curtain cloth 4 consists of a light-blocking part 41 and a light-transmitting part 42 set alternately, said light-transmitting part 42 being a light-transmitting muslin net, said light-blocking part 41 being a light-impermeable cloth surface, and the curtain as a whole is in a light-blocking state when adjacent light-blocking parts 41 are rotated to a horizontal position, and the curtain as a whole is in a light-transmitting state when adjacent light-blocking parts 41 are rotated to a vertical position.

The adjacent hanging tabs 3 on the two adjacent curtain walking bead devices are connected to the same curtain fabric 4.

The said partition 1, the connecting member 5 at the upper part of the partition, and the hanging plate 2 at the lower part of the partition are integrally molded.

### Example of implementation 3-7:

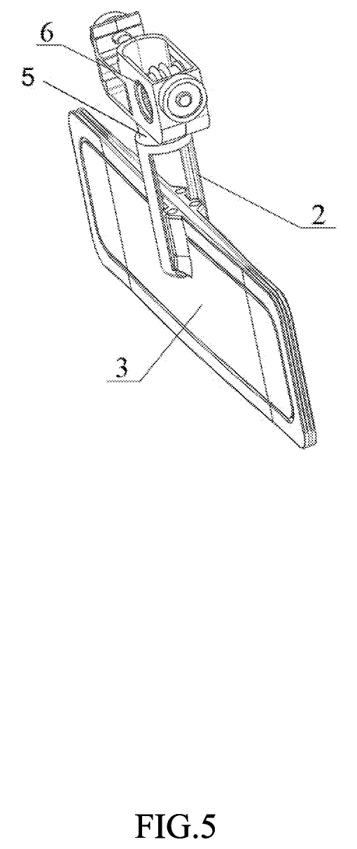

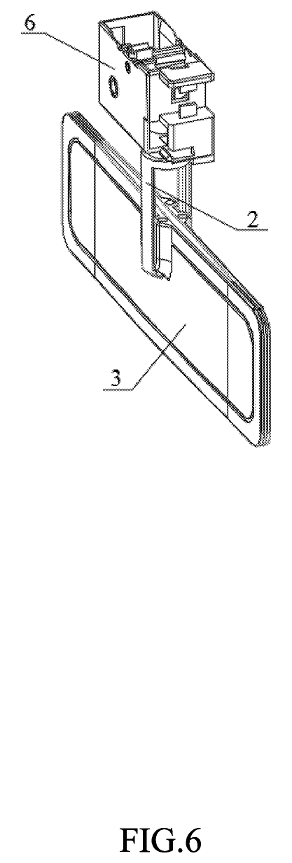

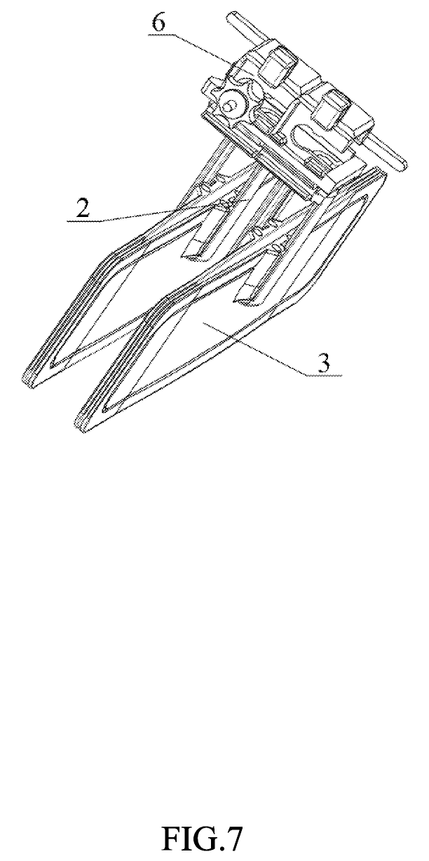

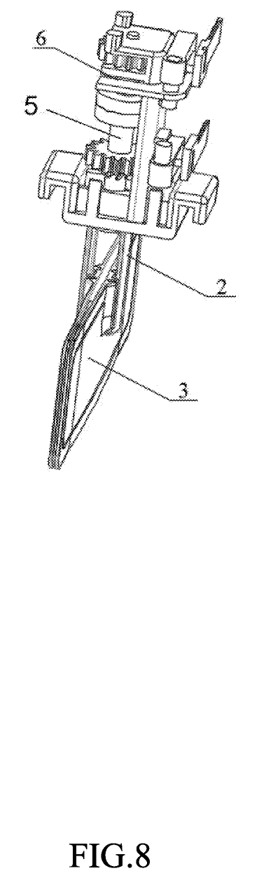

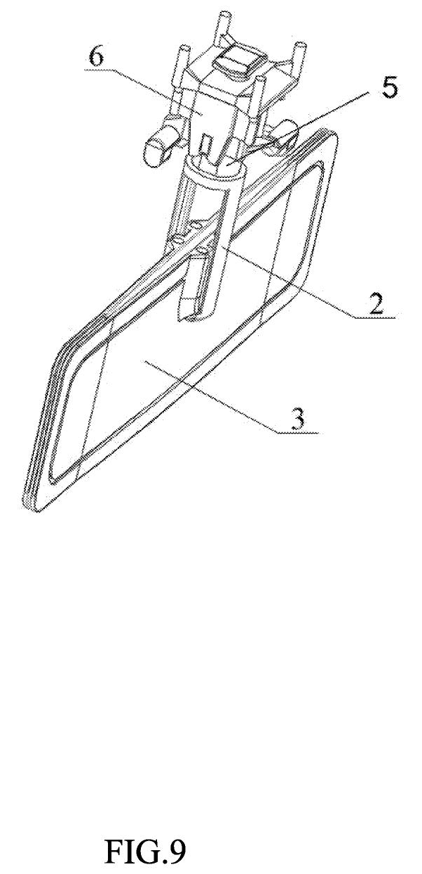

As shown in FIGS. 5-9, there is a schematic diagram of the structure of different connecting members and different walking grooves used in combination with the bead walking device of the patent.

What is claimed is:

1. A curtain bead walking device, characterized in that it includes a partition plate and two hanging plates symmetrically provided in the lower part of the partition plate, the ends of the two hanging plates are bent upwardly and extended to form hooks, and the two hooks are provided opposite to each other, and said bead walking device further comprises a hanging piece which is fitted with the hooks, and a hook slot is provided in the middle part of said hanging piece to be fitted with the hooks.

2. A curtain bead walking device according to claim 1, characterized in that: a vertical limiting strip is provided in the middle of the hanging plate, the limiting strip runs through the hooks, dividing the hooks into a left hook body and a right hook body, and said hanging piece is provided in the middle of the hanging plate with a left hook groove and a right hook groove which cooperate with the left hook body and the right hook body, respectively. The left hook slot and the right hook slot are provided with through holes through them in the upper part.

3. A curtain beading device according to claim 2, characterized in that said beading device comprises two hanging plates and two hanging tabs cooperating with the two hanging plates, the hanging tabs having a curtain fabric attached thereto, the curtain fabric being connected to the hanging tabs in a manner of sewing, heat fusion, bonding or welding.

4. A curtain bead walking device according to claim 3, characterized in that said hanging piece is in the form of a thin sheet, and the upper edge of the hanging piece is lower than the upper edge of the curtain cloth by 0-10 mm, and the width of said left hook slot and right hook slot is greater than the width of the left hook body and the right hook body.

5. A curtain bead walking device according to claim 4, characterized in that said bead walking device further comprises a connecting member set in the upper part of the partition, and a bead walking groove cooperating with the connecting member, and the bead walking groove drives the hanging plate and the hanging sheet to move on the curtain track, thereby driving the curtain fabric to move.

6. A curtain bead-walking device according to claim 5, characterized in that: said through-hole is provided with an adjustment member for adjusting the tilt angle of the hanging plate and the curtain fabric.

7. A curtain, characterized in that it comprises a curtain bead walking device as claimed in claim 1, wherein a number of curtain bead walking devices are provided in a curtain track, which move left and right along the curtain track and rotate at a certain angle under the action of a driving device, thereby driving the curtain fabric to move left and right and rotate at a certain angle.

8. A curtain according to claim 7, characterized in that: said curtain cloth comprises a light-shading part and a light-transmitting part set alternately, said light-transmitting part being a light-transmitting muslin mesh, and said light-shading part being a light-impermeable cloth surface, when adjacent light-shading part is rotated to a horizontal position, the curtain as a whole is in a light-shading state, when adjacent light-shading part is rotated to a vertical position, the curtain as a whole is in a light-transmitting state, and the curtain as a whole is in a light-transmitting state. When the adjacent light-blocking portions are rotated to the vertical position, the curtain as a whole is in a light-transmitting state.

9. A curtain according to claim 8, characterized in that the adjacent hanging tabs on the two adjacent curtain walking bead devices are connected to the same curtain fabric.
A curtain according to claim 9, characterized in that: said partition, the connecting member at the upper part of the partition, and the hanging plate at the lower part of the partition are integrally molded.
